(19) United States
(12) Patent Application Publication
(10) Pub. No.: US 2024/0083782 A1
(43) Pub. Date: Mar. 14, 2024

(54) DEVICE FOR PRODUCING A CLOSED CURRENT CIRCUIT WITH A FLOWABLE MEDIUM AND A VIBRATING METAL CONDUCTOR

(71) Applicant: DR. HIELSCHER GMBH, Teltow (DE)

(72) Inventors: Thomas HIELSCHER, Potsdam (DE); Holger HIELSCHER, Rangsdorf (DE); Harald HIELSCHER, Stahnsdorf (DE)

(73) Assignee: DR. HIELSCHER GMBH, Teltow (DE)

(21) Appl. No.: 18/272,740

(22) PCT Filed: Feb. 7, 2022
(86) PCT No.: PCT/EP2022/052815

§ 371 Date: Jul. 17, 2023

(30) Foreign Application Priority Data
Feb. 16, 2021 (DE) 10 2021 103 545.7

(51) Int. Cl. C02F 1/461; C02F 1/463

(52) U.S. Cl. CPC C02F 1/46114; C02F 1/463; C02F 2001/46123

(57) ABSTRACT

The invention relates to a device for building a closed current circuit A, in which electric charge carriers move at least through a metal conductor, a flowable medium and a resonantly mechanically vibrating metal conductor C, which is mechanically connected to elements which generate mechanical vibrations. The device is characterized in that the current circuit B generating the previously mentioned resonant mechanical vibrations is decoupled from the previously mentioned current circuit A and from the components transmitting mechanical vibrations between the elements generating vibrations and the resonantly mechanically vibrating metal conductor C, which is in contact with the flowable medium, by means of electrically non-conductive coupling elements on two sides of the vibration-generating elements.

The invention relates to a device for building a closed current circuit with a flowable medium and a vibrating metal conductor.

### BACKGROUND OF THE INVENTION

Electric charge carriers are ions, electrons or elementary particles.

Electric current (current) is the movement of electric charge carriers in a preferred direction through a conductor, e.g. a wire, a piece of metal ora flowable medium. The direction of current is always parallel to the direction of the electric field E.

An electrode is an electrically conductive part (mostly made from metal), which enables the charge exchange between two media or generates an electric field. The positive electrode is termed the anode and the negative electrode is termed the cathode.

Resonant vibrations are mechanical vibrations of a component or a component composite with a working frequency of 15 to 200 kHz, preferably 15 to 60 kHz, e.g. 20 kHz and a mechanical power above 5 W, preferably 25 W to 20 000 W, e.g. 4000 W. During the vibration, points of the component or the component composite move in a regular manner around a rest position.

Flowable media (medium, media) are e.g. fluids, gases, liquids, melts, plasmas, supercritical gases, liquid metals, dispersions, emulsions, cell suspensions, pastes, dyes, polymers, resins, electrolytes, water, heavy water, neutral, alkaline or acidic solutions, alkaline solutions or acids, waste water, slurry, ore solutions and suspensions, and nanomaterials, or mixtures of the previously mentioned substances. Flowable media may have different viscosities of 0 cP to 30 000 000 000 cP, preferably of 0.1 cP to 1 000 000 cP, e.g. 200 cP and may be thixotropic or rheopectic, Newtonian or non-Newtonian, shear-thinning or shear-thickening.

Piezoceramic or magnetostrictive vibration exciters are used for example to generate resonant vibrations. Linear vibration exciters and flat or curved plate resonators or tubular vibration exciters are known. Resonant vibrations are used inter alia in the treatment of liquids and other flowable media, e.g. foods, cosmetics, dyes, chemicals and nanomaterials. For this, resonant vibrations are transmitted into flowable media, preferably into liquids, electrolytes, alkaline or acidic solutions or molten salts, e.g. into electrolytes, by means of a resonator with amplitudes of 0.05 to 350 μm, preferably 0.5 to 80 μm, e.g. 20 μm.

Lambda is the wavelength which results from the frequency of the resonant vibration and the sound propagation speed in the component or component composite or in the resonator.

A resonant vibrating system may consist of one or more lambda/2 elements. A vibrating system consisting of a plurality of lambda/2 elements may be produced from a piece of material of corresponding length or assembled from a plurality of components or component composites of the length n*lambda/2 (nϵN), e.g. by screw fastening. Lambda/2 elements may have various material cross-sectional geometries, e.g. circular, oval or rectangular cross sections. The cross-sectional geometry and area may vary along the longitudinal axis of a lambda/2 element. The cross-sectional area may be between 0.01 and 300 cm², preferably between 10 and 100 cm², e.g. 50 cm².

Lambda/2 elements may inter alia be manufactured from metallic or ceramic materials or from glass, particularly from titanium, titanium alloys, steel or steel alloys, aluminium or aluminium alloys, e.g. from grade 5 titanium. A lambda/2 element may be manufactured from a piece of material of corresponding length or consist of a plurality of pieces of material which are connected to one another.

Vibrating systems and lambda/2 elements which consist of more than one piece of material can be combined in various ways to form a composite. A typical form of the composite is a vibrating system which is compressed by means of centrally positioned clamping elements.

Piezoceramic composite vibrating systems consist of one or more lambda/2 elements connected in the longitudinal direction of which at least one has one or more vibration-exciting, preferably piezoceramic or magnetostrictive, e.g. piezoceramic elements, in the form of discs, rings, disc segments or ring segments, e.g. piezo rings. One such lambda/2 element is termed an active lambda/2 element. A lambda/2 element without vibration-exciting elements is termed a passive lambda/2 element.

Passive lambda/2 elements without vibration-exciting elements can be mechanically connected to one or more previously mentioned active lambda/2 elements in such a manner that the mechanical vibrations are completely or partially, preferably substantially completely, transmitted with little loss of power (<10%) from the active lambda/2 element to the passive lambda/2 element.

Further lambda/2 elements without vibration-exciting elements can be mechanically connected to the previously mentioned passive lambda/2 element in such a manner that the mechanical vibrations are completely or partially, preferably substantially completely, transmitted with little loss of power (<10%) from one passive lambda/2 element to the connected passive lambda/2 element.

The connection of the active and passive lambda/2 elements to one another usually takes place by screw fastening at the maximum or close to the maximum of the vibration excursion, e.g. in the longitudinal direction of the vibration propagation direction.

Especially piezoceramic resonant vibrating systems require an increased surface pressure at the coupling point between two lambda/2 elements. This surface pressure may be between 0.1 and 1000 N/mm², preferably between 1 and 10 N/mm², e.g. 5 N/mm². The surface pressure has considerable effects on the efficiency, the maximum possible mechanical transmission power and on the resonant frequency. Therefore, the surface pressure inter alia may be chosen such that the efficiency is maximized and/or the losses are minimized during transmission of the mechanical vibrations.

The surface pressure between an active lambda/2 element and a passive lambda/2 element or between two lambda/2 elements is usually generated by at least one clamping element, e.g. by a centrally positioned tightening screw, e.g. a steel screw or a titanium threaded rod.

The application of resonant vibrations to electrodes is a novel technology with advantages for many different processes in electrolysis, galvanization, electrocleaning, hydrogen generation and electrocoagulation, particle synthesis or other electrochemical reactions, on a laboratory or pilot scale and in industrial production.

Electrolysis is the exchange of atoms and ions by the removal or addition of electrons as a consequence of the application of an electric current. The products of the electrolysis may have a different physical state than the electrolyte. During electrolysis, solids, such as e.g. deposits or solid layers, may arise on one of the electrodes. Alternatively, the electrolysis may generate gases, such as e.g. hydrogen, chlorine or oxygen. The resonant vibration of an electrode may break solid deposits off from the electrode surface or quickly generate larger gas bubbles from dissolved gases or microbubbles. The latter leads to a faster separation of the gaseous products from the electrolyte.

During the electrolysis process, the products accumulate in the vicinity of the electrodes or on the electrode surface. Resonant vibrations, particularly those which generate cavitation in the flowable medium surrounding the electrode, are a very effective means for increasing the mass transfer at boundary layers. This effect brings fresh electrolyte into contact with the electrode surface. The cavitational flow transports products of the electrolysis, such as gases or solids, away from the electrode surface. The formation of insulating layers, which inhibit the electrolytic processes, is prevented as a result.

A resonant vibration of the anode, the cathode or both electrodes may influence the decomposition potential or the decomposition voltage. It is known that by itself, the cavitation breaks molecules, generates free radicals or ozone. The combination of cavitation with electrolysis may influence the required minimum voltage for electrolysis between the anode and cathode of an electrolysis cell or may influence the current flow between anode and cathode of an electrolysis cell. The mechanical and chemical effects of the cavitation may likewise improve the energy efficiency of the electrolysis.

During electrorefining, solid deposits of metals, such as e.g. copper, in the electrolyte can be converted into a suspension of solid particles. During electroextraction, the electrolytic deposition of metals from their ores may be converted into a solid deposit. Conventional electrolyte metals are lead, copper, gold, silver, zinc, aluminium, chromium, cobalt, manganese and the rare earth and alkali metals. Cavitation induced by mechanical vibrations is also an effective means during the leaching of ores.

Liquids, such as e.g. aqueous solutions such as waste water, slurry or the like, can be passed for cleaning through the electric field of two electrodes. Aqueous solutions can be disinfected or purified by electrolysis. When an NaCl solution together with water is guided through electrodes or over electrodes, Cl₂ or ClO₂ is created, which can oxidize contaminants and disinfect the water or the aqueous solutions. If the water contains sufficient natural chlorides, the addition is not necessary.

Resonant vibrations of the electrodes can make the boundary layer between the electrode and the water as thin as possible. This may improve the mass transfer by many orders of magnitude. Due to a resonant vibration and possibly due to cavitation caused by these vibrations, the formation of microscopically small bubbles is reduced considerably owing to the polarization. The use of resonantly vibrating electrodes for electrolysis processes improves the electrolytic cleaning process considerably.

Electrocoagulation is a waste water treatment method for removing contaminants such as emulsified oil, total petroleum hydrocarbons, fire-resistant organic substances, suspended solids and heavy metals. Radioactive ions can also be removed for water purification. The use of resonantly vibrating electrodes during electrocoagulation, also termed sono-electrocoagulation, has a positive influence on the chemical oxygen requirement or the efficiency of the turbidity removal. Such combined electrocoagulation treatment methods have shown a greatly improved performance during the removal of hazardous substances from industrial waste waters. The integration of a free-radical-producing step, such as e.g. the cavitation due to the resonant vibrations in the flowable medium surrounding the electrode with the electrocoagulation, shows synergistic effects and improvements in the entire purification process. The purpose of using such hybrid systems consists in increasing the total treatment efficiency and overcoming the disadvantages of conventional treatment methods. It was proven that hybrid electrocoagulation reactors inactivate Escherichia coli in water.

Many chemical processes, such as e.g. heterogeneous reactions or catalysis, profit from the agitation using resonant vibrations and the resultant cavitation. The chemical influence of the cavitation may increase the reaction rate or improve the conversion yield.

Resonant vibrating electrons add a novel powerful tool for chemical reactions. The advantages of the chemical effects of the resonant vibrations and the cavitation can be combined with the electrolysis. Hydrogen, hydroxide ions, hypochlorite and many other ions or neutral materials may be generated directly at the electrode in the cavitation field. Cavitation-assisted electrolysis makes hydrogen production more economical and more energy efficient. The products of the electrolysis can be used as reagents or as reaction partners of the chemical reaction. Resonant vibrating electrodes can generate reactants by means of cavitation or withdraw products of chemical reactions, in order to shift the final equilibrium of the chemical reaction or to change the chemical reaction path.

Pulsed electric field (PEF) technology is a non-thermal method e.g. for preserving food, in which short current pulses are used e.g. for microbial inactivation, whilst the food quality is only minimally reduced. PEF is known as a non-thermal method for the microbial decontamination of foods. It includes the generation of electric fields (5-50 kV/cm) with the aid of short high-voltage pulses between two electrodes, which leads e.g. to microbial inactivation at lower temperatures than in the case of thermal methods. A passive lambda/2 element, which functions as an electrode, enables the combination of PEF with high-frequency vibrations or cavitation, e.g. in order to increase the effectiveness of microbial inactivation or to achieve a mechanical mixing by means of vibration- or cavitation-induced flow to prevent channelling in the PEF.

Liquid which is moved by resonant vibrations is known from the prior art, which is not located between non-resonantly-vibrating electrodes. Shading and propagation patterns of the vibration waves in the liquid lead to poorer results compared to direct resonant electrode vibration. Electrodes, preferably anodes or cathodes, may be loaded with ultrasound vibrations.

A pressure-tight seal is possible between the passive lambda/2 element, which functions as electrode, and a reactor vessel. As a result, the electrolysis cell may be operated at a pressure that is different from ambient pressure. This may be of interest, if gases are created during the electrolysis, when operating at higher temperatures or when operating using highly volatile components, e.g. using solvents or liquids with a low boiling point. A tightly closed electrochemical reactor can be operated at pressures above or below ambient pressure. The seal between the passive lambda/2 element, which functions as electrode, and the reactor may be realized in an electrically conductive or insulating manner. The latter makes it possible to operate the reactor walls as a second electrode. The reactor may have inlet and outlet openings, preferably in each case one inlet and outlet opening, e.g. in order to function as a continuous or discontinuous flow-through cell reactor for continuous or discontinuous processes.

If the passive lambda/2 element, which functions as an electrode, is located in the vicinity of a second non-agitated electrode or in the vicinity of a reactor wall, the ultrasound waves propagate through the liquid and the ultrasound waves also act on the other exposed surfaces. A passive lambda/2 element, which functions as an electrode and is aligned e.g. concentrically in a tube or in a reactor, can keep the tube or reactor inner walls free from contaminants or from accumulated solids.

When using a passive lambda/2 element, which functions as electrode, the electrolyte temperature may lie between −273 degrees Celsius and 3000 degrees Celsius, preferably between −50 degrees Celsius and 300 degrees Celsius, e.g. between −5 degrees Celsius and 100 degrees Celsius.

If the viscosity of the electrolyte inhibits the mass transfer, the mixing due to resonant vibrations of the electrode during the electrolysis may be advantageous, as it improves the transfer of the material to and from the electrodes.

Pulsing current in a lambda/2 element, which functions as electrode, leads to products which differ from those when using direct current (DC). For example, pulsing current may increase the ratio of ozone to oxygen, which is created at the anode during the electrolysis of an aqueous acidic solution, e.g. diluted sulphuric acid. The pulsing current electrolysis of ethanol creates an aldehyde instead of a primarily acidic solution.

### SUMMARY OF THE INVENTION

The invention discloses a device for building a closed current circuit A according to claim 1. Further preferred embodiments of the invention can be drawn from the dependent claims and the following description.

The building according to the invention of a closed current circuit A, in which electric charge carriers move at least through a metallic conductor, a flowable medium and a resonantly mechanically vibrating metallic conductor C, which is mechanically connected to elements which generate mechanical vibrations, is characterized in that the current circuit B generating the previously mentioned resonant mechanical vibrations is decoupled from the previously mentioned current circuit A and from the components transmitting mechanical vibrations between the elements generating vibrations and the resonantly mechanically vibrating metallic conductor C, which is in contact with the flowable medium, by means of electrically non-conductive coupling elements on two sides of the vibration-generating elements.

The electrical insulation distance between the current circuits A and B is more than 0 mm, preferably between 0.01 mm and 50 mm, e.g. 2 mm. The applied voltage e.g. for an electrolytic process on a flowable medium by means of at least one resonantly mechanically vibrating metallic conductor C, which is mechanically connected to elements which generate mechanical vibrations, may be more than 0 volt, e.g. between 0.1 volt and 3000 volts, e.g. 20 volts. The current intensity transmitted, e.g. for an electrolytic process, from at least one resonantly mechanically vibrating metallic conductor C, which is mechanically connected to elements which generate mechanical vibrations, to the surrounding flowable medium may be more than 0 ampere, preferably between 0.5 and 100 amperes, e.g. 20 amperes. The specific current intensity transmitted, e.g. for an electrolytic process, from at least one resonantly mechanically vibrating metallic conductor C, which is mechanically connected to elements which generate mechanical vibrations, to the surrounding flowable medium may be more than 0 ampere per square centimetre, preferably between 0.01 and 10 amperes per square centimetre, e.g. 0.5 ampere per square centimetre, of the contact area between the vibrating metal conductor C and the surrounding flowable medium.

The resonantly mechanically vibrating metallic conductor C, which is mechanically connected to elements which generate mechanical vibrations, may consist of electrically conductive materials, preferably of high-grade steel, titanium, titanium alloys, steel, nickel-chromium-molybdenum, aluminium or niobium, e.g. of a titanium alloy.

The resonantly mechanically vibrating metallic conductor C, which is mechanically connected to elements which generate mechanical vibrations, can be earthed and e.g. connected to the ground of the socket or to a protective earth contact (e.g. residual current device).

The voltage applied for the electrolytic process to the resonantly mechanically vibrating metal conductor C, which is mechanically connected to elements which generate mechanical vibrations, may be a direct current voltage (DC), a pulsing DC voltage or an alternating current voltage (AC), preferably a direct current voltage (DC) or a pulsing direct current voltage, e.g. a direct current voltage (DC). The resonantly mechanically vibrating metal conductor C, which is mechanically connected to elements which generate mechanical vibrations, can be operated as an anode or as a cathode.

The specific power transmitted mechanically by means of resonant vibrations over the surface of the resonantly mechanically vibrating metallic conductor C to the surrounding flowable medium, the liquid or the electrolyte may be between 1 watt and 100 watts per square centimetre, preferably between 3 watts and 30 watts per square centimetre, e.g. 15 watts per square centimetre.

According to the invention, a device and a method for building a closed current circuit A are disclosed, in which electric charge carriers move at least through a metallic conductor, a flowable medium and a resonantly mechanically vibrating metallic conductor C, which is mechanically connected to elements which generate mechanical vibrations, wherein this current circuit A is electrically insulated from the current circuit B, which generates the previously mentioned resonant mechanical vibrations. This is achieved by means of electrically non-conductive coupling elements on two sides of the vibration-generating elements.

For the electrically insulating connection of a resonantly mechanically vibrating metallic conductor C, which preferably functions as an electrode in an electrolytic process, one insulator in each case (non-conductor, insulating material, dielectric, non-conductive component), preferably one insulator in each case made from a hard material, such as e.g. ceramic, glass, quartz, diamond or plastic, e.g. from ceramic, is mechanically clamped on two sides of the elements, which generate mechanical vibrations, between the components which are to be mechanically coupled and electrically insulated.

The components and clamping elements used for the clamping are electrically insulating in such a manner, e.g. formed by means of an insulation sleeve, that the electrical resistance between the resonantly mechanically vibrating metallic conductor C and the elements which generate mechanical vibrations is more than 10 ohms, preferably more than 1000 ohms, e.g. more than 100 000 ohms.

The insulator positioned between the components which are to be coupled mechanically and insulated electrically may be between 0 mm and 150 mm, preferably between 0.01 mm and 50 mm, e.g. 2 mm thick.

The voltage source of the current circuit A can be operated with a constant, variable, pulsed or programmatically controlled voltage. A potentiostat can measure the electric voltage and/or the electric current and output the same as measured values. The current of the current circuit A may be constant, variable, pulsed or may be controlled programmatically. A galvanostat can keep the electric currents in the current circuit A constant and detect the electric voltage applied at the flowable medium, which results therefrom. The potentiostat can keep the electric voltage applied at the flowable medium between the electrodes constant and detect the electric current which results therefrom.

### SHORT DESCRIPTION OF THE FIGURES

FIG. 1 shows a device according to the invention according to an exemplary embodiment.

FIG. 2 shows a device according to the invention according to a further exemplary embodiment.

FIG. 3 shows a device according to the invention according to a further exemplary embodiment.

FIG. 4 shows a device according to the invention according to a further exemplary embodiment.

FIG. 5 shows a device according to the invention according to a further exemplary embodiment.

FIG. 6 shows a device according to the invention according to a further exemplary embodiment.

### DETAILED DESCRIPTION

The invention is explained in more detail in the following on the basis of drawings and exemplary embodiments.

### Exemplary Embodiments

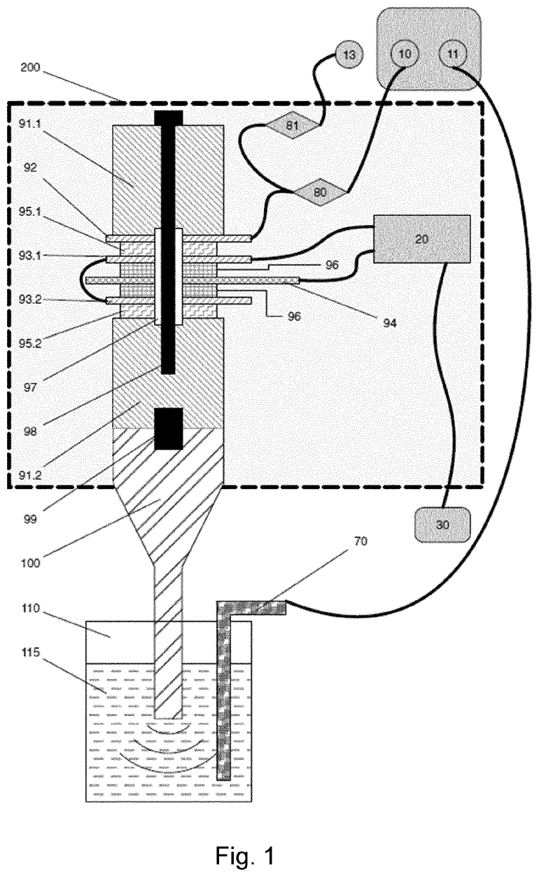

FIG. 1 shows a structure according to the invention of the device. A voltage source having the two contacts 10 and 11 may be a direct current voltage source (DC), pulsed direct current voltage source (PDC), an alternating current voltage source (AC) or a pulsed alternating current voltage source (PAC), preferably a direct current voltage source (DC) or a pulsed direct current voltage source (PDC), e.g. a direct current voltage source. This voltage source can be located inside or outside the housing 200, e.g. preferably outside the housing 200. The housing 200 may be electrically conductive or insulating, e.g. electrically insulating. The contact 10 of the voltage source is connected via an electrical conductor, e.g. via a cable, to a fuse 80, e.g. a safety fuse. The fuse 80 can be located inside or outside the housing 200, e.g. inside the housing 200. A further electrical conductor connects this fuse 80 to a contact disc 92. An insulator 95.1, e.g. a ceramic disc or glass disc, separates the contact disc 92 from a contact disc 93.1. An insulator 95.2, e.g. a ceramic disc or glass disc, separates a component 91.2 from a further contact disc 93.2. The contact discs 93.1, 93.2 and 94 are connected to a generator 20, e.g. an ultrasound generator or a high-frequency generator and the elements 96 which generate the mechanical vibrations to form a current circuit B. The elements 96 which generate mechanical vibrations may be e.g. piezoceramic discs or piezoceramic perforated discs, preferably piezoceramic perforated discs.

The generator 20 is supplied by a current source 30 with direct current or alternating current, e.g. alternating current at 50 Hz or 60 Hz and with a voltage, e.g. 115V+/−20% or 230V+/−20%. The generator 20 can be located inside or outside the housing 200, e.g. inside the housing 200.

The fuse 80 may have a surge protector 81, e.g. a thyristor or a protective circuit, which is in turn connected to a protective earth contact 13 or an earthing contact.

A clamping element 98, e.g. a tightening screw or a threaded bolt, preferably a clamping screw, clamps mechanically vibrating components 91.1 and 91.2 with the elements 96 which generate the mechanical vibrations. An insulating sleeve 97, which is made from an electrically nonconductive material, e.g. a plastic sleeve, and surrounds the clamping element 98, is installed for the electrical insulation of the clamping element 98 from the elements 96 which generate the mechanical vibrations.

A further clamping element 99 connects a resonantly mechanically vibrating metallic conductor C 100 to the mechanically vibrating component 91.2.

The resonantly mechanically vibrating metallic conductor C 100 is e.g. made from titanium and is in contact with a flowable medium 115, e.g. a liquid, which is located in a vessel 110. A further electrical conductor 70, e.g. an electrode, is connected to the contact 11 of the voltage source.

The resonantly mechanically vibrating metallic conductor C 100 transmits mechanical vibrations to the flowable medium 115, e.g. to generate cavitation.

The voltage transmitted via the contact element 92 to the adjacent component 91.1 is transmitted via the clamping element 98 to the component 91.2. This is adjoined by the resonantly mechanically vibrating metallic conductor C 100, which is additionally connected via the clamping element 99. The clamping element 98, e.g. a clamping screw or a threaded bolt, is electrically conductive. The same applies for the components 91.1 and 91.2 and the resonantly mechanically vibrating metallic conductor C 100.

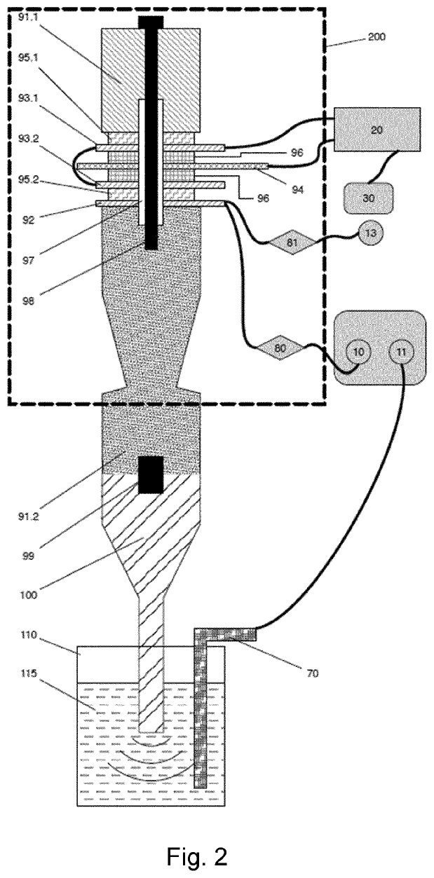

FIG. 2 shows a structure according to the invention. A voltage source having the two contacts 10 and 11 may be a direct current voltage source (DC), pulsed direct current voltage source (PDC), an alternating current voltage source (AC) or a pulsed alternating current voltage source (PAC), preferably a pulsed direct current voltage source (PDC). This voltage source is located outside of the housing 200. The housing 200 may be electrically conductive or insulating, e.g. electrically conductive. The contact 10 of the voltage source is connected via an electrical conductor, e.g. via a cable, to a fuse 80, e.g. a safety fuse. The fuse 80 is located inside the housing 200. A further electrical conductor connects this fuse 80 to the contact disc 92. A ceramic insulator 95.2 separates the contact disc 92 from a contact disc 93.2. An insulator 95.1, e.g. a ceramic disc or glass disc, separates a component 91.1 from a further contact disc 93.1. The contact discs 93.1, 93.2 and 94 are connected to an ultrasound generator and the elements 96 which generate mechanical vibrations (e.g. piezoceramic perforated discs) to form a current circuit B. The generator 20 is supplied by a current source 30 with direct current or alternating current, e.g. alternating current at 50 Hz or 60 Hz and with a voltage, e.g. 115V+/−20% or 230V+/−20%. The generator 20 is located outside the housing 200.

A surge protector 81, e.g. a thyristor or a protective circuit, connects the contact disc 92 to a protective earth contact 13 or an earthing contact.

A clamping element 98, e.g. a clamping screw or a threaded bolt, preferably a threaded bolt, clamps mechanically vibrating components 91.1 and 91.2 with the elements 96 which generate the mechanical vibrations. An insulating sleeve 97, which is made from an electrically nonconductive material, e.g. a ceramic sleeve, and surrounds the clamping element 98, is installed for the electrical insulation of the clamping element 98 from the elements 96 which generate the mechanical vibrations.

A further clamping element 99 connects the resonantly mechanically vibrating metallic conductor C 100 to the mechanically vibrating component 91.2.

The resonantly mechanically vibrating metallic conductor C 100 is e.g. made from titanium and is in contact with a flowable medium 115, e.g. a liquid, which is located in a vessel 110. A further electrical conductor 70, e.g. an electrode, is connected to the contact 11 of the voltage source.

The resonantly mechanically vibrating metallic conductor C 100 transmits mechanical vibrations to the flowable medium 115, e.g. to generate cavitation.

The component 91.2 and the resonantly mechanically vibrating metallic conductor C 100 are electrically conductive.

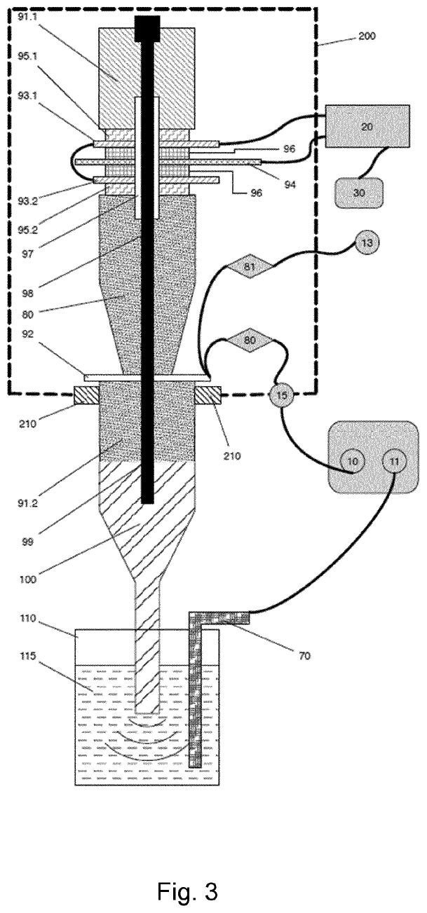

FIG. 3 shows a structure according to the invention. A voltage source having the two contacts 10 and 11 is located outside of the housing 200. The housing 200 may be electrically conductive or insulating, e.g. electrically conductive. An insulator 210, e.g. a component made from rubber, plastic or ceramic, insulates the electrically conductive housing 200 from a component 91.2 which is electrically connected to the current circuit A. The contact 10 of the voltage source is connected via an electrical conductor, e.g. via a cable to a connector 15. This connector may be mounted e.g. in the housing 200. A further electrical conductor connects a connector 15 to a fuse 80, e.g. a safety fuse. The fuse 80 is located inside the housing 200. A further electrical conductor connects this fuse 80 to the contact disc 92. A ceramic insulator 95.2 separates a component 80 from the contact disc 93.2. A further ceramic insulator 95.1 separates the component 91.1 from the contact disc 93.1. The contact discs 93.1, 93.2 and 94 are connected to an ultrasound generator and the elements 96 which generate mechanical vibrations (e.g. piezoceramic perforated discs) to form a current circuit B. The generator 20 is supplied by a current source 30 with direct current or alternating current, e.g. direct current, and with a voltage between 0 volt and 3000 volts, preferably between 6 volts and 600 volts, e.g. 24 volts. The generator 20 is located inside or outside, preferably outside the housing 200.

A surge protector 81, e.g. a thyristor, connects the contact disc 92 to a protective earth contact 13 or an earthing contact.

A clamping element 98, e.g. a clamping screw or a threaded bolt, preferably a threaded bolt, clamps mechanically vibrating components 80, 91.1 and 91.2 and the resonantly mechanically vibrating metallic conductor C 100 with the elements 96 which generate the mechanical vibrations. An insulating sleeve 97, which is made from an electrically non-conductive material, e.g. a plastic tube, and surrounds the clamping element 98, is installed for the electrical insulation of the clamping element 98 from the elements 96 which generate the mechanical vibrations.

The resonantly mechanically vibrating metallic conductor C 100 is e.g. made from high-grade steel and is in contact with a f flowable medium 115, e.g. an electrolyte, which is located in a vessel 110. A further electrical conductor 70, e.g. an electrode, is connected to the contact 11 of the voltage source.

The resonantly mechanically vibrating metallic conductor C 100 transmits mechanical vibrations to the flowable medium 115, e.g. to generate cavitation.

The component 91.2 and the resonantly mechanically vibrating metallic conductor C 100 are electrically conductive.

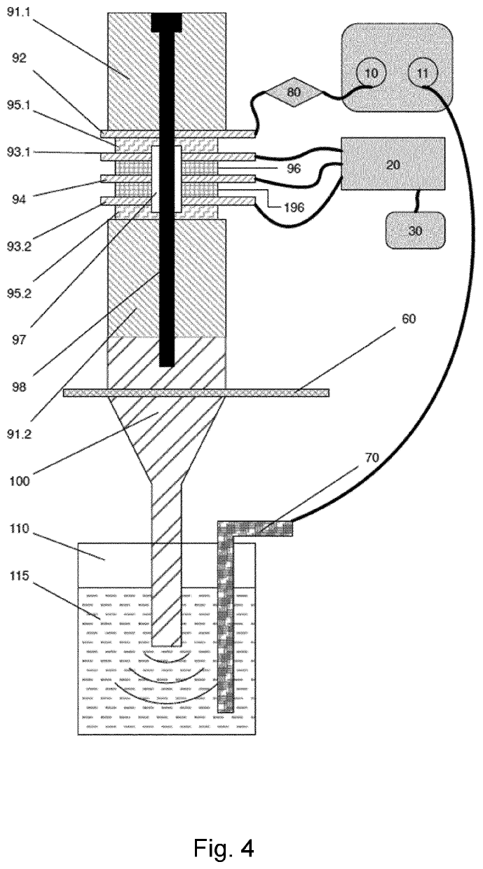

FIG. 4 shows a structure according to the invention. The contact 10 of a voltage source is connected via an electrical conductor, e.g. via a cable, to a fuse 80, e.g. a safety fuse. A further electrical conductor connects this fuse 80 to the contact disc 92. An insulator 95.1, e.g. a ceramic disc or glass disc, insulates the contact disc 92 from the contact disc 93.1. An insulator 95.2, e.g. a ceramic disc or glass disc, insulates the component 91.2 from the contact disc 93.2. The contact discs 93.1, 93.2 and 94 are connected to an ultrasound generator and the elements 96 which generate mechanical vibrations to form a current circuit B. The elements 96 which generate mechanical vibrations may be e.g. piezoceramic discs or piezoceramic perforated discs, preferably piezoceramic perforated discs. A clamping screw 98 clamps mechanically vibrating components 91.1, 91.2 and the resonantly mechanically vibrating metallic conductor C 100 with the elements 96 which generate the mechanical vibrations. An insulating sleeve 97, which is made from an electrically non-conductive material, e.g. a plastic sleeve, and surrounds the clamping element 98, is installed for the electrical insulation of the clamping element 98 from the elements 96 which generate the mechanical vibrations. The resonantly mechanically vibrating metallic conductor C 100 is e.g. made from grade 5 titanium and is in contact with a liquid 115, which is located in a vessel 110. A further electrical conductor 70, e.g. an electrode, is connected to the contact 11 of the voltage source. A mounting component 60 is connected, close to a minimum of the vertical excursion caused by the resonant vibrations, to the resonantly mechanically vibrating metallic conductor C 100. The resonantly mechanically vibrating metallic conductor C 100 transmits mechanical vibrations to the flowable medium 115, e.g. to generate acoustic flows.

The voltage transmitted via the contact element 92 to the adjacent component 91.1 is transmitted via the clamping element 98 to the component 91.2. This is adjoined by the resonantly mechanically vibrating metallic conductor C 100. The clamping element 98 is electrically conductive. The same applies for the components 91.1 and 91.2 and the resonantly mechanically vibrating metallic conductor C 100.

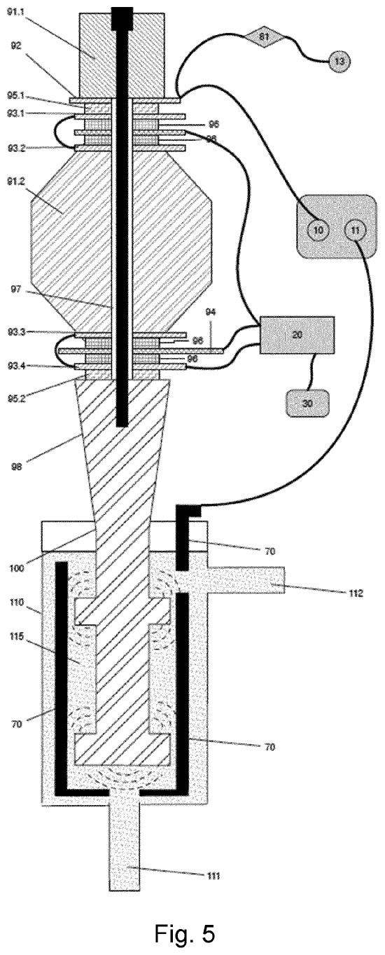

FIG. 5 shows a structure according to the invention. The contact 10 of a voltage source is connected via a cable of the contact disc 92. A ceramic insulator 95.1 separates the component 91.1 from the contact disc 93.1. A ceramic insulator 95.2 separates the resonantly mechanically vibrating metallic conductor C 100 from the contact disc 93.4. The contact discs 93.1, 93.2, 93.3, 93.4 and 94 are connected to an ultrasound generator and the elements 96 which generate mechanical vibrations (e.g. piezoceramic perforated discs) to form a current circuit B. The generator 20 is supplied by a current source 30. A surge protector 81, e.g. a thyristor, connects the contact disc 92 to a protective earth contact 13 or an earthing contact.

A clamping element 98, e.g. a clamping screw or a threaded bolt, preferably a threaded bolt, clamps mechanically vibrating components 91.1, 91.2 and the resonantly mechanically vibrating metallic conductor C 100 with the elements 96 which generate the mechanical vibrations. An insulating sleeve 97, which is made from an electrically non-conductive material, e.g. a plastic tube, and surrounds the clamping element 98, is installed for the electrical insulation of the clamping element 98 from the elements 96 which generate the mechanical vibrations.

The resonantly mechanically vibrating metallic conductor C 100 is e.g. made from steel and is in contact with a flowable medium 115, e.g. a supercritical gas, which flows through into a pressure-tight vessel 110. The openings 112 and 111 function in this case as inlet or outlet for the vessel 110. A further electrical conductor 70, e.g. an electrode, is connected to the contact 11 of the voltage source.

The resonantly mechanically vibrating metallic conductor C 100 transmits mechanical vibrations to the flowable medium 115, e.g. to generate cavitation.

The voltage transmitted via the contact element 92 to the adjacent component 91.1 is transmitted via the clamping element 98 to the resonantly mechanically vibrating metallic conductor C 100. The clamping element 98 is electrically conductive. The same applies for the component 91.1 and the resonantly mechanically vibrating metallic conductor C 100.

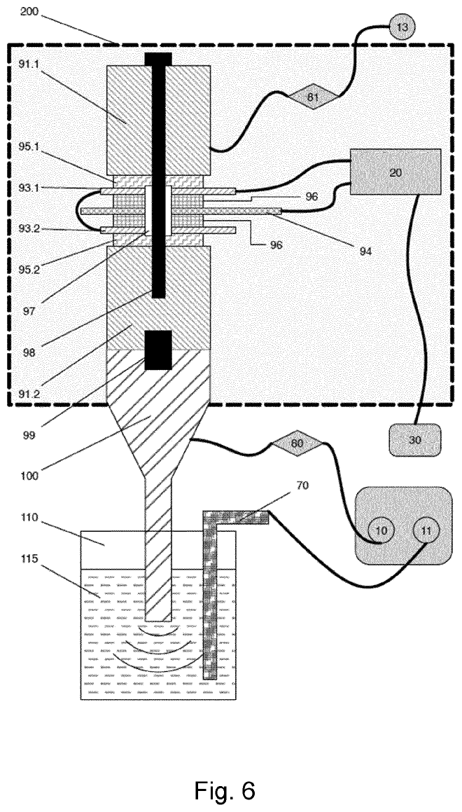

FIG. 6 shows a structure according to the invention. A voltage source having the two contacts 10 and 11 may be a direct current voltage source (DC), pulsed direct current voltage source (PDC), an alternating current voltage source (AC) or a pulsed alternating current voltage source (PAC), e.g. a direct current voltage source. This voltage source can be located inside or outside the housing 200, e.g. preferably outside the housing 200. The housing 200 may be electrically conductive or insulating, e.g. electrically insulating. The contact 10 of the voltage source is connected via an electrical conductor, e.g. via a cable, to a fuse 80, e.g. a safety fuse. The fuse 80 can be located inside or outside the housing 200, e.g. inside the housing 200. A further electrical conductor connects this fuse 80 to the resonantly mechanically vibrating conductor C 100. An insulator 95.1, e.g. a ceramic perforated disc or glass perforated disc, separates the electrically conductive component 91.1 from the contact disc 93.1. An insulator 95.2, e.g. a ceramic perforated disc or glass perforated disc, separates the electrically conductive component 91.2 from the contact disc 93.2. The contact discs 93.1, 93.2 and 94 are connected to a generator 20, e.g. an ultrasound generator or a high-frequency generator and the elements 96 which generate the mechanical vibrations to form a current circuit B. The elements 96 which generate mechanical vibrations may be e.g. piezoceramic discs or piezoceramic perforated discs, preferably piezoceramic perforated discs.

The generator 20 is supplied by a current source 30 with direct current or alternating current, e.g. alternating current at 50 Hz and with a voltage, e.g. 230 volts. The generator 20 can be located inside or outside the housing 200, e.g. inside the housing 200.

The component 91.1 may be connected to a surge protector 81, e.g. a thyristor or a protective circuit, which in turn is connected to a protective earth contact 13 or an earthing contact.

A clamping element 98, e.g. a clamping screw or a threaded bolt, preferably a tightening screw, clamps mechanically vibrating components 91.1, 91.2 and the resonantly mechanically vibrating metallic conductor C 100 with the elements 96 which generate the mechanical vibrations. An air gap 97, which surrounds the clamping element 98, is provided for the electrical insulation of the clamping element 98 from the elements 96 which generate the mechanical vibrations.

A further clamping element 99 connects the resonantly mechanically vibrating metallic conductor C 100 to the mechanically vibrating component 91.2.

The resonantly mechanically vibrating metallic conductor C 100 is e.g. made from metal and is in contact with a flowable medium 115, e.g. a liquid, which is located in a vessel 110. A further electrical conductor 70, e.g. an electrode, is connected to the contact 11 of the voltage source.

The resonantly mechanically vibrating metallic conductor C 100 transmits e.g. mechanical vibrations to degas the flowable medium 115.

1. Device for building a closed current circuit A, in which electric charge carriers move at least through a metallic conductor, a flowable medium and a resonantly mechanically vibrating metallic conductor C, which is mechanically connected to elements which generate mechanical vibrations, characterized in that the current circuit B generating the previously mentioned resonant mechanical vibrations is decoupled from the previously mentioned current circuit A and from the components transmitting mechanical vibrations between the elements generating vibrations and the resonantly mechanically vibrating metallic conductor C, which is in contact with the flowable medium, by means of electrically non-conductive coupling elements on two sides of the vibration-generating elements.

2. The device according to claim 1, wherein the device is configured in such a manner that a working frequency of the resonantly mechanically vibrating metal conductor C, which is in contact with the flowable medium, lies in the range of 15 to 200 kHz.

3. The device according to claim 1, wherein the electrically non-conductive coupling elements are clamped by means of a clamping element with a surface pressure between 0.1 and 1000 N/mm², with the elements which generate the vibrations.

4. The device according to claim 1, wherein the resonantly mechanically vibrating metal conductor C, which is in contact with the flowable medium, is clamped by means of a clamping element with the components transmitting mechanical vibrations between the elements which generate vibrations and the resonantly mechanically vibrating metal conductor C, which is in contact with the flowable medium, with a surface pressure of between 0.1 and 1000 N/mm², with the elements which generate the vibrations.

5. The device according to claim 1, wherein the flowable medium in current circuit A is an electrolyte.

6. The device according to claim 1, wherein the resonantly mechanically vibrating metal conductor C, which is in contact with the flowable medium, consists of a metallic material, preferably of a titanium alloy.

7. The device according to claim 1, wherein the device is configured in such a manner that
the current circuit A initiates or supports an electrolytic process in the flowable medium; or
the current circuit A initiates or supports a pulsed electric field (PEF) process in the flowable medium; or
the current circuit A initiates or supports the electrolytic production of a gas in the flowable medium; or
the current circuit A initiates or supports an electrolytic coagulation in the flowable medium; or
the current circuit A initiates or supports an electrochemical precipitation reaction in the flowable medium; or
the resonantly mechanically vibrating metal conductor C, which is in contact with the flowable medium, generates cavitation in the flowable medium.

8. The device according to claim 7, wherein the resonantly mechanically vibrating metal conductor C, which is in contact with the flowable medium, functions as an anode or cathode in an electrolytic process.

9. The device according to claim 7, wherein the resonantly mechanically vibrating metal conductor C, which is in contact with the flowable medium, functions as an electrode in a pulsed electric field (PEF).

10. The device according to claim 1, wherein an electrically insulating pressure-tight seal is present between the resonantly mechanically vibrating metal conductor C, which is in contact with the flowable medium, and a reactor vessel.

11. The device according to claim 1, wherein the device is configured in such a manner that there is an electrolyte temperature of between −50 degrees Celsius and 300 degrees Celsius.

12. The device according to claim 1, wherein an electrical insulation distance between the current circuits A and B is between 0.01 mm and 50 mm.

13. The device according to claim 1, wherein the device is configured in such a manner that
a voltage between the resonantly mechanically vibrating metal conductor C, which is in contact with the flowable medium, and a further electrical conductor, which is in contact with the flowable medium, in current circuit A is between 0.1 volt and 5000 volts; or
the voltage between the resonantly mechanically vibrating metal conductor C, which is in contact with the flowable medium, and a further electrical conductor, which is in contact with the flowable medium, in current circuit A is between 1000 volts and 70 000 volts per cm distance between these two conductors.

14. The device according to claim 1, wherein the device is configured in such a manner that
a current intensity transmitted via the resonantly mechanically vibrating metal conductor C, which is in contact with the flowable medium, to the flowable medium is between 0.5 and 100 amperes; or
the current intensity transmitted via the resonantly mechanically vibrating metal conductor C, which is in contact with the flowable medium, to the flowable medium is between 0.01 and 10 amperes per square centimetre contact area between the resonantly mechanically vibrating metal conductor C, which is in contact with the flowable medium, and the flowable medium.

15. The device according to claim 1, wherein the device is configured in such a manner that
the current circuit A has a fuse to limit the maximum current intensity in the current circuit; or
the current circuit A has a fuse to limit the maximum voltage in the current circuit A; or
the current circuit A has a fuse to limit the maximum power in the current circuit A; or
the current circuit A has a component or a circuit, a protective circuit or a spark gap, which leads to a switch off of at least one of the two current circuits, if the two current circuits are no longer electrically insulated from one another; or
the current circuit A has a component, which is connected to an earthing contact or protective earth contact, or a circuit, which is connected to an earthing contact or protective earth contact, which leads to a switch off of at least one of the two current circuits, if the two current circuits are no longer electrically insulated from one another.

16. The device according to claim 1, wherein the device is configured in such a manner that
a direct current voltage (DC) is applied to the current circuit A; or
a pulsed direct current voltage (DC) is applied to the current circuit A; or
an alternating current voltage (AC) is applied to the current circuit A.

17. The device according to claim 1, wherein the device is configured in such a manner that a power transmitted mechanically by means of vibrations to the surrounding flowable medium via the contact area between the resonantly mechanically vibrating metal conductor C and the flowable medium is between 3 watts and watts per square centimetre of contact area.

18. The device according to claim 1, wherein the electrically non-conductive coupling elements are made from ceramic, glass, quartz, diamond or plastic.
